(19) United States
(12) Patent Application Publication
(10) Pub. No.: US 2021/0125224 A1
(43) Pub. Date: Apr. 29, 2021

(54) CLOUD OPERATING SYSTEM FOR ADVERTISING PLAN AND APPLICATION THEREOF

(71) Applicant: LI-JUN YANG, TAICHUNG CITY (TW)

(72) Inventors: SHIH-I CHEN, TAICHUNG CITY (TW); LI-JUN YANG, TAICHUNG CITY (TW)

(21) Appl. No.: 16/877,727

(22) Filed: May 19, 2020

(30) Foreign Application Priority Data
Oct. 29, 2019 (TW) 108139048

(51) Int. Cl. G06Q 30/02

(52) U.S. Cl. CPC G06Q 30/0258; G06Q 30/0209; G06Q 50/01; G06Q 30/0276; G06Q 30/0267

(57) ABSTRACT

A cloud operating system for an advertising plan contains: a user interface, a login page and a manager interface. The user interface is a mobile communication device or a computer. The login page includes an operating program installed on a cloud server so as to execute a logging in step, a linking step, a running step, a rewarding step, a consolidation step, and a feedback step. The login page is configured to install a mobile application or a web program of a browser so as to link network communication and to login the web page, and dynamic update information is sent to the user interface from the login page. The manager interface is a computer system program of a manager to run at least one sub-function, such as security control, information uploading, game running, and data management.

### FIELD OF THE INVENTION

The present invention relates to a cloud operating system for an advertising plan which is applied to execute an advertisement promotion plan, to gather user's consumption data, and to provide instant using information.

### BACKGROUND OF THE INVENTION

Referring to FIG. 1, a conventional advertisement promotion plan for a house sales contains a step of providing a budget of an advertising promotion to a builder or an advertisement contractor B before executing the house sales, wherein an advertisement promotion plan CS is executed by ways of: an advertising publication A1, an event promotion A2, a video platform A3, and a gift rewarding A4.

The advertising publication A1 contains signboards, newspapers, or magazines. The event promotion A2 includes a variety of sales promotions A2. The video platform A3 includes TV commercials, online shows or radio shows. The gift rewarding A4 has giving prizes or providing discount.

However, the target consumers cannot be learned by executing the conventional advertisement promotion plan. The prize cannot attract the target consumers, and the advertisement promotion plan cannot be learned by the target consumers widely.

In addition, the advertisement promotion plan is spread by using a network or a Quick Response code (QR code) so that the consumers read advertisement information preset in the web page. However, the advertisement promotion plan cannot be pushed to the target consumers automatically, and updated information and new events of the advertisement promotion plan cannot be provided to the target consumers quickly.

The present invention has arisen to mitigate and/or obviate the afore-described disadvantages.

### SUMMARY OF THE INVENTION

The primary aspect of the present invention is to provide a cloud operating system for an advertising plan which is applied to execute an advertisement promotion plan, to gather user's consumption data, and to provide instant using information.

Further aspect of the present invention is to provide a cloud operating system for an advertising plan by which the dynamic updated information is pushed to the user automatically via the login page so that the user obtains favorable message via the user interface, the user gives or sells the prize or the discount to other users after logging in the login page, and the could server promotes an advertising sales case inclusive of the prize or the discount to the other users.

Another aspect of the present invention is to provide a cloud operating system for an advertising plan by which the prizes and the discounts are calculated and are applicable for product or service consumption of the advertisement promotion plan, and the manager learns a result of the advertisement promotion plan so as to adjust the advertisement promotion plan quickly.

To obtain the above aspects, a cloud operating system for an advertising plan provided by the present invention contains: a user interface, a login page, and a manager interface.

The user interface is a mobile communication device or a computer.

The login page includes an operating program installed on a cloud server so as to execute a logging in step, a linking step, a running step, a rewarding step, a consolidation step, and a feedback step, wherein the login page is configured to install a mobile application or a web program of a browser so as to link network communication and to login the web page, and dynamic update information is sent from the login page to the user interface for a user's reading.

The manager interface is a computer system program of a manager, wherein the manager interface is configured to run a security control, an information uploading, a game running, and a data management, wherein the security control is configured to let the user interface to link, to log in the login page, and to save user's information in the logging in step, wherein the information uploading includes user sharing information, advertiser or event information, and user's reading information which is displayed in the login page, the game running is installed based on an advertisement marketing plan so as to provide a downloadable game program after the user longs in, the game running includes advertisement placing information shown during downloading the game, game rules, reward description, a prize content and probability set in the downloadable game program, wherein the data management is configured to provide readable information to the user and to save the readable information after the game running, wherein the readable information includes a stage running result, a login account, a password, a ranking record, prizing information, friend information, sharing information, and a score ranking of the game program.

In another embodiment, a cloud operating system for an advertising plan contains: a user interface, a login page, and a manager interface.

The user interface is a mobile communication device or a computer.

The login page includes an operating program installed on a cloud server so as to execute a logging in step, a linking step, a running step, a rewarding step, a consolidation step, and a feedback step, wherein the login page is configured to install a mobile application or a web program of a browser so as to link network communication and to login the web page, and dynamic update information is sent from the login page to the user interface for a user's reading.

The manager interface is a computer system program of a manager, wherein the manager interface is configured to run a security control, an information uploading, a game running, and a data management.

In the logging in step, the mobile application is installed or the user enters into the login page by ways of the browser so as to read an operation description displayed in the login page.

In the linking step, the user longs in and saves the security control, and security control includes the login account, the password, a lost password recovery, and a social platform account setting by linking the login account after the logging in step.

In the running step, the dynamic update information is uploaded to the user interface by ways of the cloud server for the user's reading after logging in the login page, wherein the dynamic update information includes a game linking, the advisement or event information, wherein the game linking, the advisement or the event information is preset in the manager interface based on an advertising plan, and a next page is displayed so that the user links, runs, or downloads the program after logging in the login page, and the advertisement information is sent to the user in the login page via the could server.

In the running step, when clicking the advertisement information or pushing the dynamic updated information after logging in the could server, the could server distributes clicking award points to the user.

In the rewarding step, the user links and plays the game so as to obtain a prize based on the prize content or reviews the advertisement information to learn a discount message after the running step, wherein the discount message is saved in the cloud server via the login page, the prize or a discount is distributed from a budget of the advertising plan, and the manager controls prize items and discount distributions of the advertising plan, the prize items and the discount distributions are saved in the could server and are readable by inputting the login account, the password, and authorization codes.

In the consolidation step, the user links with the could server to acquire saved information which includes the game or read discount information after the running step, and the user shares the saved information to the social platform account so as to promote the advertisement information, and the user reads the score ranking of the game program.

In the feedback step, wherein the user links the could server to acquire saved information which includes the game or the read discount information after the running step, and the user gives or sells the prize or the discount to other users, in the meantime, the could server promote an advertisement promotion plan inclusive of the prize or the discount to the other users.

### BRIEF DESCRIPTION OF THE DRAWINGS

FIG. 1 is a flow chart view showing the execution of a conventional advertisement promotion plan.

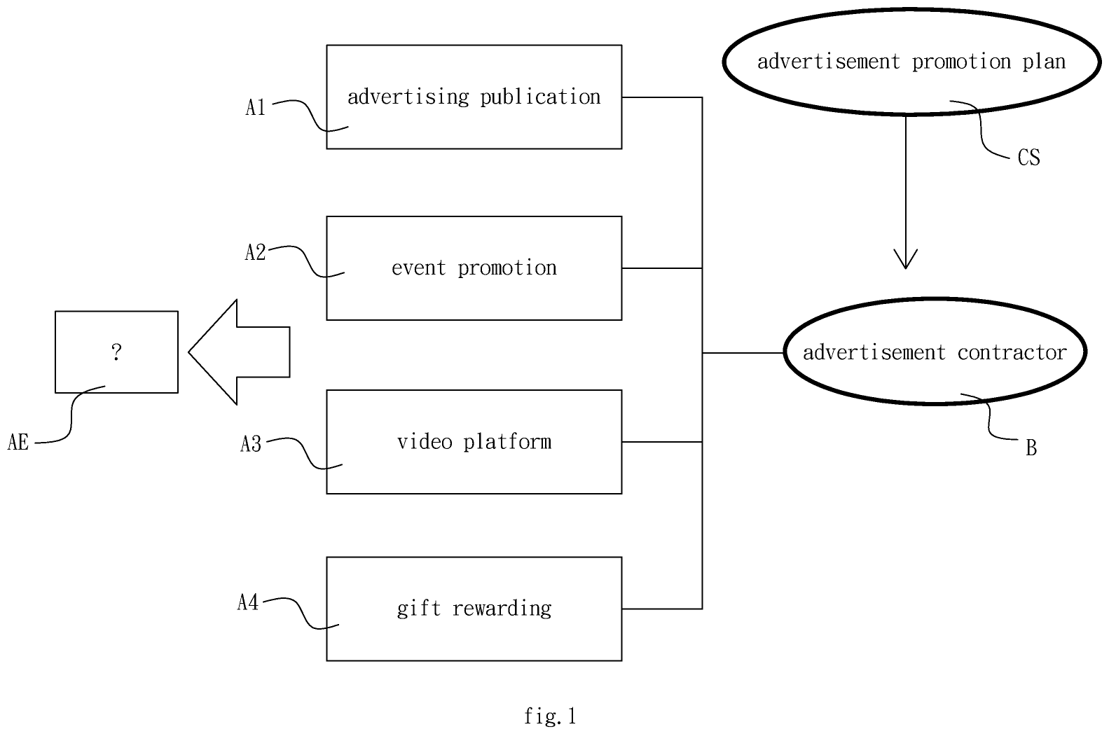

FIG. 2 is a flow chart of a cloud operating system for an advertising plan according to a preferred embodiment of the present invention.

FIG. 3 is a flow chart of the logging in step of the cloud operating system for the advertising plan according to the preferred embodiment of the present invention.

FIG. 4 is a side plan view showing the application of the cloud operating system for the advertising plan according to the preferred embodiment of the present invention.

### DETAILED DESCRIPTION OF THE PREFERRED EMBODIMENTS

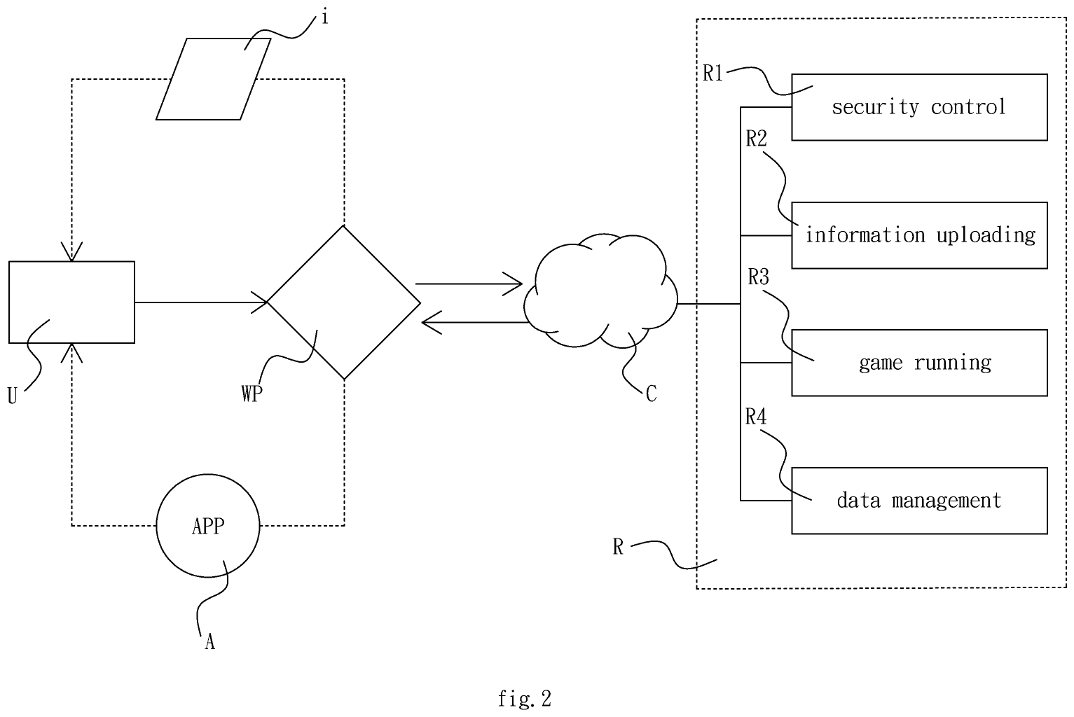

With reference to FIG. 2, a cloud operating system for an advertising plan according to a preferred embodiment of the present invention is applied to execute an advertisement promotion plan CS, to gather user's consumption data, and to provide instant using information.

The cloud operating system comprises: a user interface U, a login page WP, and a manager interface R.

The user interface U is a mobile communication device or a computer.

The login page WP includes an operating program installed on a cloud server C so as to execute a logging in step S1, a linking step S2, a running step S3, a rewarding step S4, a consolidation step S5, and a feedback step S6. In addition, the login page WP is configured to install a mobile application A (APP) or a web program of a browser so as to link network communication and to login the web page WP, and dynamic update information i is sent from the login page WP to the user interface U for a user's reading.

The manager interface R is a computer system program of a manager. The manager interface R is configured to run at least one sub-functions such as a security control R1, an information uploading R2, a game running R3, and a data management R4, wherein the security control R1 is configured to let the user interface U to link, to log in the login page WP, and to save user's information in the logging in step S1, wherein the user's information includes a login account, a password settings and management, corresponding community platform accounts (such as FB/Google accounts, etc.) and login history. The information uploading R2 includes user sharing information, advertiser or event information, and user's reading information which is displayed in the login page WP. The game running R3 is installed based on an advertisement marketing plan so as to provide a downloadable game program after the user longs in. The game running R3 includes advertisement placing information shown during downloading the game, game rules, reward description, a prize content and probability set in the downloadable game program. The data management R4 is configured to provide readable information to the user and to save the readable information after the game running R, wherein the readable information includes a stage running result, the login account, a password, a ranking record, prizing information, friend information, sharing information, and a score ranking of the game program.

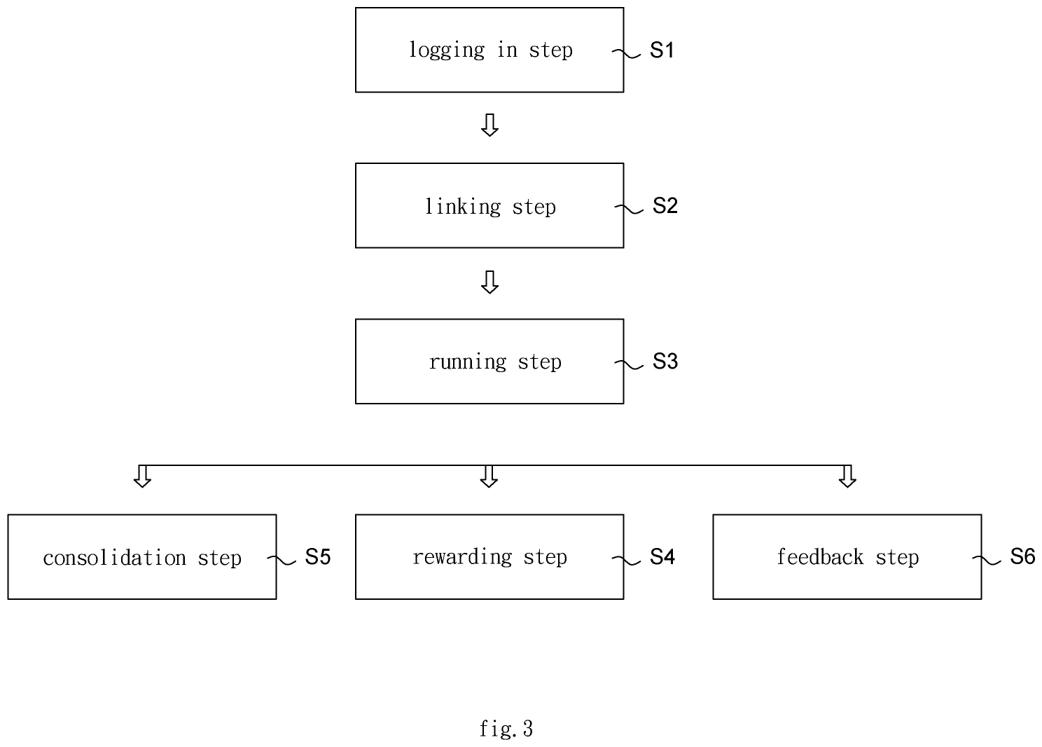

Referring to FIG. 3, after linking the user interface and logging in the login page WP, a running procedure is executed in:

the logging in step S1, wherein the mobile application A is installed or the user enters into the login page WP by ways of the browser so as to read an operation description displayed in the login page WP;

the linking step S2, wherein the user longs in and saves the security control, such as the login account, the password, a lost password recovery, and a social platform account setting by linking the login account after the logging in step S1;

the running step S3, wherein the dynamic update information i is uploaded to the user interface U by ways of the cloud server C for the user's reading after logging in the login page WP, wherein the dynamic update information i includes a game linking, the advisement or event information, wherein the game linking, the advisement or the event information is preset in the manager interface R based on the advertising plan, and a next page is displayed so that the user links, runs, or downloads the program after logging in the login page WP, and the advertisement information is sent to the user in the login page WP via the could server C, and the could server C pushes the dynamic updated information to the user automatically after the user reviews the advertisement information, and when clicking the advertisement information or pushing the dynamic updated information after logging in the could server C, the could server C distributes clicking award points to the user;

the rewarding step S4, wherein the user links and plays the game so as to obtain a prize based on the prize content or reviews the advertisement information to learn a discount message after the running step S3, wherein the discount message is saved in the cloud server C via the login page WP, the prize or a discount is distributed from a budget of the advertising plan, and the manager controls prize items and discount distributions of the advertising plan, the prize items and the discount distributions are saved in the could server C and are readable by inputting the login account, the password, and authorization codes, for example, when selling houses, the prize items have home appliance gifts, and voucher has the discount;

the consolidation step S5, wherein the user links the could server C to acquire saved information (such as the game or read discount information) after the running step S3, and the user shares the saved information to the social platform account so as to promote the advertisement information, and the user reads the score ranking of the game program;

the feedback step S6, wherein the user links with the could server C to acquire saved information (such as the game or the read discount information) after the running step S3, and the user gives or sells the prize or the discount to other users, in the meantime, the could server C promote an advertising sales case inclusive of the prize or the discount to the other users;

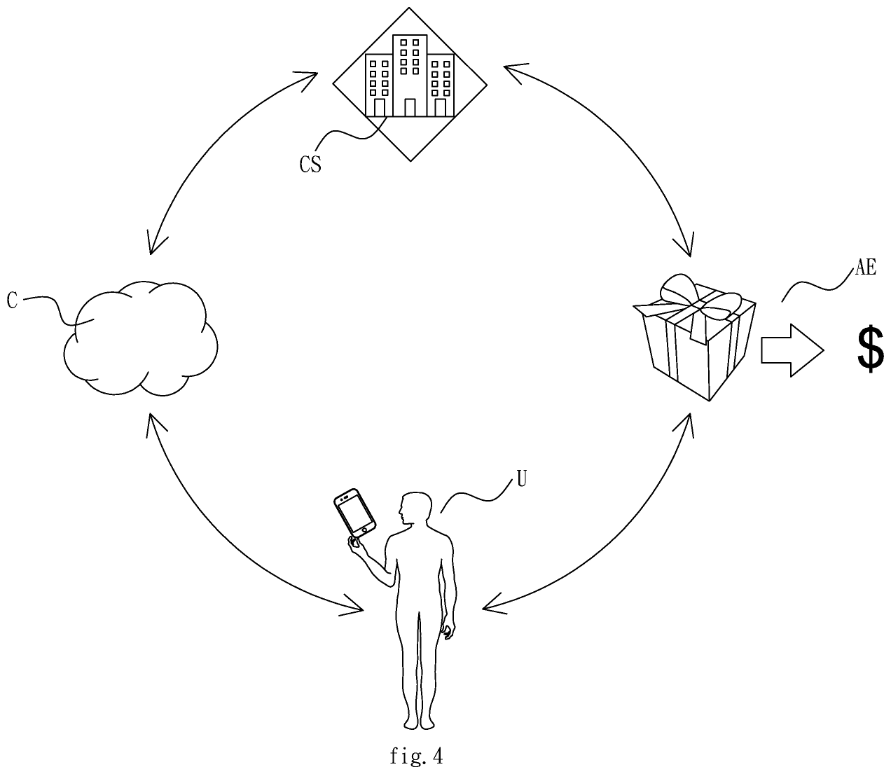

As illustrated in FIG. 4, when the cloud operating system is applicable for executing the advertisement promotion plan CS, the could server C is linked to the user interface U, when the user links to the could server C via a video platform or a network platform, the advertisement information is acquired by the user in the logging in step S1, the linking step S2, the running step S3, the rewarding step S4, the consolidation step S5, and the feedback step S6. Preferably, the dynamic updated information is pushed to the user automatically via the login page WP so that the user obtains favorable message via the user interface U. Preferably, the user gives or sells the prize or the discount to other users after logging in the login page WP, and the could server C promote an advertising sales case inclusive of the prize or the discount to the other users. Preferably, the prizes and the discounts are calculated and are applicable for product or service consumption of the advertisement promotion plan CS, and the manager learns a result of the advertisement promotion plan CS so as to adjust the advertisement promotion plan CS quickly.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A cloud operating system for an advertising plan comprising:
a user interface (U) being a mobile communication device or a computer;
a login page (WP) including an operating program installed on a cloud server (C) so as to execute a logging in step (S1), a linking step (S2), a running step (S3), a rewarding step (S4), a consolidation step (S5), and a feedback step (S6), wherein the login page (WP) is configured to install a mobile application (A) or a web program of a browser so as to link network communication and to login the web page (WP), and dynamic update information (i) is sent from the login page (WP) to the user interface (U) for a user's reading;
a manager interface (R) being a computer system program of a manager, wherein the manager interface (R) is configured to run a security control (R1), an information uploading (R2), a game running (R3), and a data management (R4), wherein the security control (R1) is configured to let the user interface (U) to link, to log in the login page (WP), and to save user's information in the logging in step (S1), wherein the information uploading (R2) includes user sharing information, advertiser or event information, and user's reading information which is displayed in the login page (WP), the game running (R3) is installed based on an advertisement marketing plan so as to provide a downloadable game program after the user longs in, the game running (R3) includes advertisement placing information shown during downloading the game, game rules, reward description, a prize content and probability set in the downloadable game program, wherein the data management (R4) is configured to provide readable information to the user and to save the readable information after the game running (R), wherein the readable information includes a stage running result, a login account, a password, a ranking record, prizing information, friend information, sharing information, and a score ranking of the game program.

2. The cloud operating system as claimed in claim 1, wherein the logging in step (S1), the mobile application (A) is installed or the user enters into the login page (WP) by ways of the browser so as to read an operation description displayed in the login page (WP).

3. The cloud operating system as claimed in claim 1, wherein in the linking step (S2), the user longs in and saves the security control, and security control includes the login account, the password, a lost password recovery, and a social platform account setting by linking the login account after the logging in step (S1).

4. The cloud operating system as claimed in claim 1, wherein in the running step (S3), the dynamic update information (i) is uploaded to the user interface (U) by ways of the cloud server (C) for the user's reading after logging in the login page (WP), wherein the dynamic update information (i) includes a game linking, the advisement or event information, wherein the game linking, the advisement or the event information is preset in the manager interface (R) based on an advertising plan, and a next page is displayed so that the user links, runs, or downloads the program after logging in the login page (WP), and the advertisement information is sent to the user in the login page (WP) via the could server (C).

5. The cloud operating system as claimed in claim 4, wherein in the running step (S3), when clicking the advertisement information or pushing the dynamic updated information after logging in the could server (C), the could server (C) distributes clicking award points to the user.

6. The cloud operating system as claimed in claim 1, wherein in the rewarding step (S4), the user links and plays the game so as to obtain a prize based on the prize content or reviews the advertisement information to learn a discount message after the running step (S3), wherein the discount message is saved in the cloud server (C) via the login page (WP), the prize or a discount is distributed from a budget of the advertising plan, and the manager controls prize items and discount distributions of the advertising plan, the prize items and the discount distributions are saved in the could server (C) and are readable by inputting the login account, the password, and authorization codes.

7. The cloud operating system as claimed in claim 1, wherein in the consolidation step (S5), the user links with the could server (C) to acquire saved information which includes the game or read discount information after the running step (S3), and the user shares the saved information to the social platform account so as to promote the advertisement information, and the user reads the score ranking of the game program.

8. The cloud operating system as claimed in claim 1, wherein in the feedback step (S6), the user links the could server (C) to acquire saved information which includes the game or the read discount information after the running step (S3), and the user gives or sells the prize or the discount to other users, in the meantime, the could server (C) promote an advertisement promotion plan (CS) inclusive of the prize or the discount to the other users.

9. The cloud operating system as claimed in claim 1, wherein the user's information includes the login account, a password settings and management, corresponding community platform accounts which includes FB/Google accounts, and login history.

10. A cloud operating system for an advertising plan comprising:
a user interface (U) being a mobile communication device or a computer;
a login page (WP) including an operating program installed on a cloud server (C) so as to execute a logging in step (S1), a linking step (S2), a running step (S3), a rewarding step (S4), a consolidation step (S5), and a feedback step (S6), wherein the login page (WP) is configured to install a mobile application (A) or a web program of a browser so as to link network communication and to login the web page (WP), and dynamic update information (i) is sent from the login page (WP) to the user interface (U) for a user's reading;
a manager interface (R) being a computer system program of a manager, wherein the manager interface (R) is configured to run a security control (R1), an information uploading (R2), a game running (R3), and a data management (R4);
wherein in the logging in step (S1), the mobile application (A) is installed or the user enters into the login page (WP) by ways of the browser so as to read an operation description displayed in the login page (WP);
wherein in the linking step (S2), the user longs in and saves the security control, and security control includes the login account, the password, a lost password recovery, and a social platform account setting by linking the login account after the logging in step (S1);
wherein in the running step (S3), the dynamic update information (i) is uploaded to the user interface (U) by ways of the cloud server (C) for the user's reading after logging in the login page (WP), wherein the dynamic update information (i) includes a game linking, the advisement or event information, wherein the game linking, the advisement or the event information is preset in the manager interface (R) based on an advertising plan, and a next page is displayed so that the user links, runs, or downloads the program after logging in the login page (WP), and the advertisement information is sent to the user in the login page (WP) via the could server (C);
wherein in the running step (S3), when clicking the advertisement information or pushing the dynamic updated information after logging in the could server (C), the could server (C) distributes clicking award points to the user;
wherein in the rewarding step (S4), the user links and plays the game so as to obtain a prize based on the prize content or reviews the advertisement information to learn a discount message after the running step (S3), wherein the discount message is saved in the cloud server (C) via the login page (WP), the prize or a discount is distributed from a budget of the advertising plan, and the manager controls prize items and discount distributions of the advertising plan, the prize items and the discount distributions are saved in the could server (C) and are readable by inputting the login account, the password, and authorization codes;
wherein in the consolidation step (S5), the user links with the could server (C) to acquire saved information which includes the game or read discount information after the running step (S3), and the user shares the saved information to the social platform account so as to promote the advertisement information, and the user reads the score ranking of the game program;
wherein in the feedback step (S6), wherein the user links the could server (C) to acquire saved information which includes the game or the read discount information after the running step (S3), and the user gives or sells the prize or the discount to other users, in the meantime, the could server (C) promote an advertisement promotion plan (CS) inclusive of the prize or the discount to the other users.

11. The cloud operating system as claimed in claim 10, wherein the security control (R1) is configured to let the user interface (U) to link, to log in the login page (WP), and to save user's information in the logging in step (S1), wherein the information uploading (R2) includes user sharing information, advertiser or event information, and user's reading information which is displayed in the login page (WP), the game running (R3) is installed based on an advertisement marketing plan so as to provide a downloadable game program after the user longs in, the game running (R3) includes advertisement placing information shown during downloading the game, game rules, reward description, a prize content and probability set in the downloadable game program, wherein the data management (R4) is configured to provide readable information to the user and to save the readable information after the game running (R), wherein the readable information includes a stage running result, a login account, a password, a ranking record, prizing information, friend information, sharing information, and a score ranking of the game program.

12. The cloud operating system as claimed in claim 10, wherein in the running step (S3), when clicking the advertisement information or pushing the dynamic updated information after logging in the could server (C), the could server (C) distributes clicking award points to the user.
